(19) United States
(12) Patent Application Publication
(10) Pub. No.: US 2010/0135548 A1
(43) Pub. Date: Jun. 3, 2010

(54) Medical Imaging System

(75) Inventors: Olivier GERARD, VIROFLAY (FR); Pascal ALLAIN, SAINT CYR L'ECOLE (FR); Odile BONNEFOUS, RUEIL-MALMAISON (FR); Eric SALOUX, SAINT MANVIEU-NORREY (FR); Eric DENIS, Yerres (FR)

Correspondence Address: PHILIPS INTELLECTUAL PROPERTY & STANDARDS, P.O. BOX 3001, Briarcliff Manor, NY, 10510-8001, US

(73) Assignee: KONINKLIJKE PHILIPS ELECTRONICS N.V., Eindhoven (NL)

(21) Appl. No.: 12/443,194

(22) PCT Filed: Oct. 1, 2007
(86) PCT No.: PCT/IB07/53983

§ 371 Date: Mar. 27, 2009

(30) Foreign Application Priority Data
Oct. 4, 2006 (EP) 06301012.8

(51) Int. Cl. G06K 9/62

(52) U.S. Cl. 382/128

(57) ABSTRACT

The invention relates to a medical imaging system. First, a sequence of images (SQ) of an organ (HRT) is acquired. Then, a region of tissue (PT) on said sequence of images and a parameter (P) characteristic of the motion of said region of tissue (PT) are defined. A set of phases (PH) characteristic of a cardiac cycle based on said parameter (P) is then defined. Finally, a local myocardial performance index (LMPI) for said region of tissue (PTR) based on said set of phases (PH) is computed.

### FIELD OF THE INVENTION

The present invention relates to a medical imaging system, and to a corresponding method. The invention finds, in particular, its application in the domain of echocardiographic imaging.

### BACKGROUND OF THE INVENTION

A medical imaging system is disclosed in the Journal of American College of Cardiology 1996 Vol 28, p 658-664 which makes it possible to compute a myocardial performance index MPI also known as TEI index representative of the good health of tissues of an organ. In the example disclosed, the organ is the heart. This MPI index is calculated from the timing of the velocities of the blood flow coming in and out of the left ventricle. The tissues of the heart are in good health, that means that they contract correctly, if they can carry out an efficient ejection of the blood out of the left ventricle. The smallest the MPI index is, the better the ejection is.

One drawback of said imaging system is that this MPI index gives a global representation of the health of the tissues of the heart. If there is a low blood ejection fraction, one can not know from which region of tissue it comes and one can not know which region of tissue is damaged and which one is not.

### SUMMARY OF THE INVENTION

It is an object of the invention to propose a system which permits to compute a local myocardial performance index in order to determine which tissue of an organ is damaged or not.

To this end, the system comprises a controller for controlling the following operations:
Acquisition of a sequence of images of an organ,
Determination of a region of tissue on said sequence of images,
Determination of a parameter characteristic of motion of said region of tissue,
Determination of a set of phases characteristic of a cardiac cycle based on said parameter,
Computation of a local myocardial performance index for said region of tissue based on said set of phases.

Hence, thanks to the determination of a local myocardial performance index, one may define if a region of tissue in the organ has any failure.
According to a first embodiment, the parameter is a velocity. It has the advantage of permitting a good temporal resolution in the measurement.
According to a second embodiment, the parameter is a displacement. It permits to obtain a parameter for the motion of a region of tissue along two axis, which is more precise.
According to a third embodiment, the parameter is a combination of velocity and strain. This permits to determine more precisely some phases of the cardiac cycle.
According to a not limited embodiment, the controller is also arranged to control the following operations: determination of another region of tissue on said sequence of images and determination of an associated set of phases. This permits to determine automatically other regions of tissues from a reference region of tissue. Moreover, this permits to determine a local myocardial performance index for other regions of tissues and to have a whole display of the heart parameterized with the local myocardial performance indexes.
According to a not limited embodiment, the determination of another region of tissue uses a line along the organ. This permits to determine regions of tissue in a faster way.
According to a not limited embodiment, the determination of another region of tissue is performed forwards and backwards. This permits to determine other regions of tissue in a more precise way.
According to a not limited embodiment, the determination of other sets of phases is performed with dynamic time warping. This permits to determine automatically other sets of phase by making a correlation with a reference set of phases.

The present invention also relates to a method for medical imaging which comprises the steps of:
Acquiring a sequence of images of an organ,
Determining a region of tissue on said sequence of images,
Determining a parameter characteristic of motion of said region of tissue,
Determining a set of phases characteristic of a cardiac cycle based on said parameter,
Computing a local myocardial performance index for said region of tissue based on said set of phases.

The present invention finally relates to a computer program product comprising program instructions for implementing said method.

These and other aspects of the invention will be apparent from and will be elucidated with reference to the embodiments described hereinafter.

### BRIEF DESCRIPTION OF THE DRAWINGS

The present invention will now be described in more detail, by way of not limited examples, with reference to the accompanying drawings, wherein:

FIG. 1 is a schematic drawing of an organ such as the heart, from which a sequence of images is acquired via the system according to the invention;

FIG. 2 is a schematic diagram of the system according to the invention which cooperates with a probe;

FIG. 3 is a schematic diagram of a sequence of velocity images of the heart;

FIG. 4 shows a typical velocity curve obtained from a sequence of velocity images such as the one shown in FIG. 3;

FIG. 5 is a schematic diagram showing the transformations of a sequence of velocity images to a sequence of displacement images and to a sequence of strain rate images;

FIG. 6 shows an abnormal velocity curve obtained from a sequence of velocity images such as the one shown in FIG. 3;

FIG. 7 is a not limited embodiment of a determination of a another region of tissue in the sequence of images of FIG. 3;

FIG. 8 is a matrix issued from a correlation algorithm used to correlate the velocity curve of FIG. 5 with the velocity curve of FIG. 4;

FIG. 9 is a diagram showing a search of some phases on the velocity curve of FIG. 5 based upon the correlation of FIG. 8;

FIG. 10 is a diagram showing some phases associated with some regions of tissue found with the determination of FIG. 7;

FIG. 11 represents a diagram of a not limited embodiment of a method for medical imaging according to the invention.

### DETAILED DESCRIPTION OF THE INVENTION

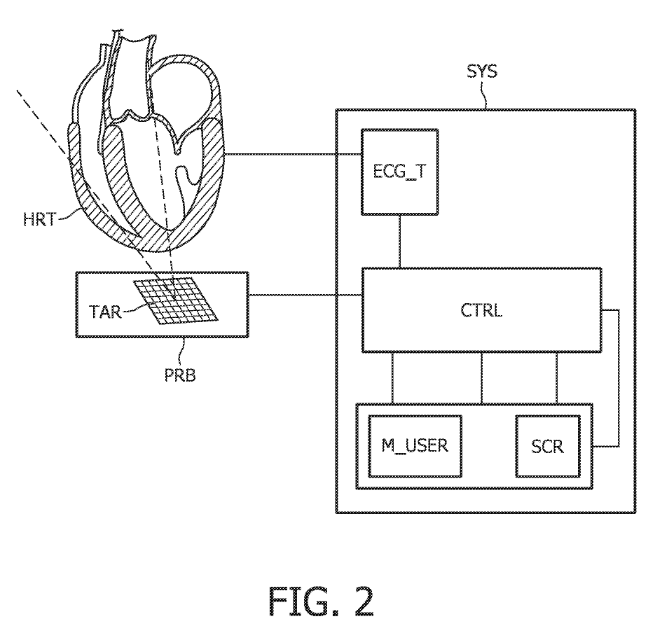

The system SYS as shown in FIG. 2 may be used to acquire images of any organ such as the heart. The example of a heart HRT will be considered in the following description.

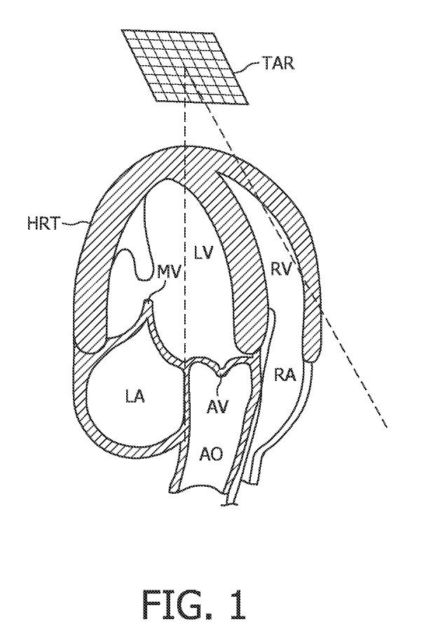

One reminds that a heart HRT is composed of a left and a right ventricles LV and RV, an aorta AO, and a left and right atrium LA and RA as shown in FIG. 1, and that the arterial blood goes from the left ventricle LV to the aorta AO while the right ventricle RV exits the venous blood received from the right atrium RA to the pulmonary artery. The aorta AO may be closed by the aorta valve AV and the left atrium may be closed by the mitral valve MV.

The system SYS is described in FIG. 2.

It cooperates with a transducer's array TAR and its associated electronics, the whole forming a probe PRB.

The system SYS comprises
a controller CTRL for controlling the following operations:
   Acquisition of a sequence of images SQ of an organ HRT (to this end the controller CTRL configures the probe PRB),
   Determination of a region of tissue PT on said sequence of images,
   Determination of a parameter P characteristic of motion of said region of tissue PT,
   Determination of a set of phases PH characteristic of a cardiac cycle based on said parameter P,
   Computation of a local myocardial performance index LMPI for said region of tissue PT based on the associated set of phases PH.

The system SYS further optionally comprises an electrocardiogram trigger ECG_T, a screen SCR for displaying the sequences of images acquired, such as a LCD screen, and a user interface M_USER.

It is to be noted that the controller CTRL comprises a microprocessor that can be preprogrammed by means of instructions or that can be programmed by a user of the system SYS, for instance via the interface M_USER.

It is to be noted that a region of tissue PT is composed of at least one point (pixel or voxel for instance) or a plurality of points (pixels or voxels for instance) within the sequence of images.

In a not limited embodiment, the controller CTRL is also arranged to control the following operations:
Determination of another region of tissue PT1 on said sequence of images SQ, and
Determination of a set of phases PH characteristic of a cardiac cycle for said other region of tissue PT1.

The operations controlled by the system SYS are described hereinafter in detail.

1) Acquisition of a sequence of images SQ.

In order to acquire a sequence of images SQ of a heart HRT, the probe PRB is applied on the body of a patient, at the apex near the heart in a not limited embodiment.

In a first embodiment, a sequence of velocity images SQVE is acquired. One uses the color Tissue Doppler Imaging method, well-known by the person skilled in the art as TDI process, to acquire velocity of displacement of a region of tissue. The result is a sequence of velocity images in a color-coded manner of the regions of tissues of the heart wall when they move, for example, towards the transducers' array TAR. Usually, the red color is associated to a contraction of a region of tissue (motion toward the transducer) and the blue color to a relaxation (motion away from the transducer). Hence, the more the images are red, the more the tissues contract and go towards the transducers' array TAR. On the contrary, the more the images are blue, the more the tissues relax and go away from the transducers' array TAR.

This TDI process has the advantage of permitting a good temporal resolution in the measurement of the velocity of a region of tissue along the axis of the transducers' array TAR.

In a second embodiment, a sequence of grey level images SQGR in two-dimensions or three dimensions is acquired.

The advantages of this second embodiment are:
to avoid a specific protocol procedure tuning like the one needed for the TDI process, as sequence of grey level is already part of clinical process, no extra acquisition is required.
the movement of a pixel along two axis is available, the longitudinal one and the radial one contrary to the TDI process where only the movement in the transducer direction is available. Hence, the movement of a pixel of the sequence of grey level images is more precise with this second embodiment.

In order for the user to choose between these two embodiments, the user interface M_USER comprises means for choosing between these two embodiments.

2) Determination of a region of tissue PT.

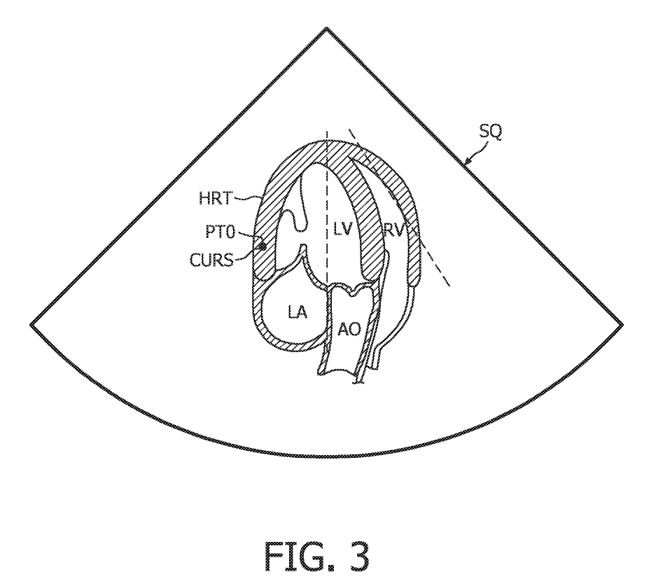

In a first embodiment, the user of the system SYS can choose a region of tissue PT by visual assessment on the sequence of images SQ as illustrated in FIG. 3. To do so, he points a cursor CURS on the sequence SQ within the wall heart at a position chosen corresponding to a region of tissue PT0 of the heart.

In a second embodiment, the choice can be performed automatically based on an associated parameter as will be described hereinafter and the user may have the choice to validate or invalidate this automatic choice.

In order for the user to choose between these two embodiments, the user interface M_USER comprises means for choosing between these two embodiments.

3) Determination of a parameter P characteristic of said region of tissue PT motion.

In a first embodiment, the parameter P is a velocity parameter.

In a second embodiment, the parameter P is a displacement parameter.

In a third embodiment, the parameter P is a combination of a strain also called deformation and of a velocity parameter.

In a fourth embodiment, the parameter P is a combination of a strain rate also called velocity gradient and of a velocity parameters.

According to one of this parameter, a curve C representing the motion of the region of tissue PT chosen is defined and may be displayed on the screen SCR of the system SYS.

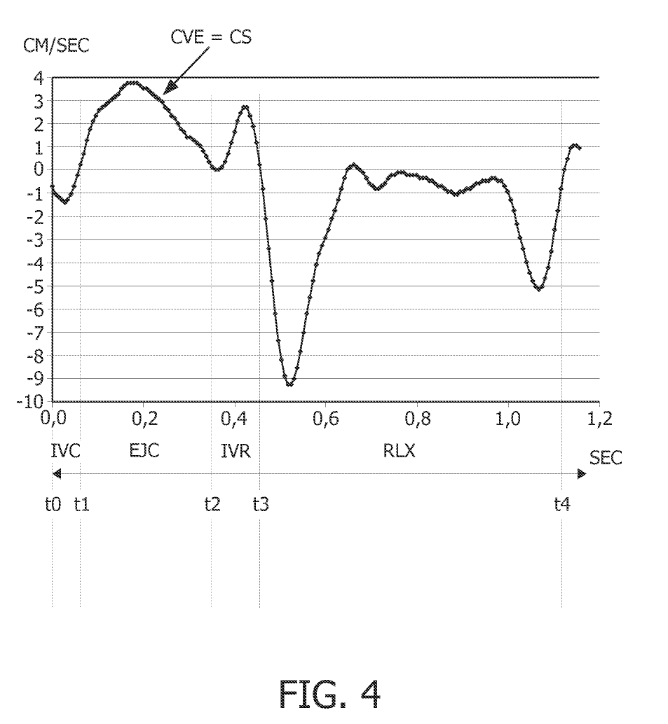

For a velocity curve CVE, the X-axis represents the time and the Y-axis represents the velocity of the motion of the region of tissue PT in centimeter per second. An example of such a curve is given in FIG. 4. Below zero, the movement of the region goes away from the transducer's array TAR, whereas above zero, the movement of the region goes towards the transducer's array TAR.

For a displacement curve CDI, the X-axis represents the time and the Y-axis represents the displacement of the region PT in centimeter. It shows the displacement of a pixel from a preceding image to a current one.

For a combination of a strain and velocity parameters, a velocity curve and a strain curve are defined. For a strain/deformation curve CST, the X-axis represents the time and the Y-axis represents the deformation between the region chosen and another region in percentage.

For a combination of a strain rate and velocity parameters, a velocity curve and a strain curve are defined. For a strain rate/velocity gradient curve CVG, the X-axis represents the time and the Y-axis is defined in second⁻¹. It represents the velocity of compression or dilatation between two regions.

In order for the user to choose between these four embodiments, the user interface M_USER comprises means for choosing between these four modes.

It is to be noted that these curves may be deducted directly or indirectly from the sequence of images acquired in step 1) either from the velocity sequence of images SQVE or from the sequence of grey level images SQGR, a sequence of images being a set of curves C associated with the set of regions PT forming the heart.

A velocity curve CVE is deducted directly from a sequence of velocity images SQVE. For example, a displacement curve CDI is deducted from a sequence of grey level images SQGR by speckle tracking or texture tracking well-known by the man skilled in the art.

In another example, a curve C may be deducted from another one by performing a derived or integral (spatial or temporal) of a curve or a plurality of curves.

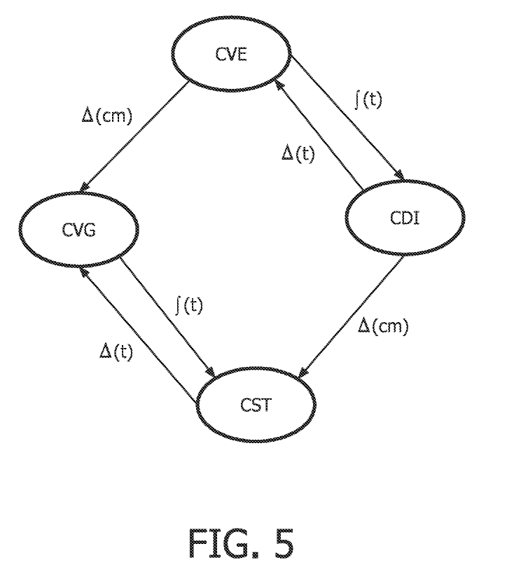

Hence, a displacement curve CDI may be deducted from a velocity curve CVE by a temporal integral and a velocity curve CVE may be deducted by a temporal derivation from a displacement curve CDI. A strain/deformation curve CST may be deducted from two displacement curves CDI by a spatial derivation. A strain rate/velocity gradient curve CVG may be deducted from two velocity curves CVE by a spatial derivation. And, finally, a strain/deformation curve CST may be deducted from a strain rate curve CVG by a temporal integral. The FIG. 5 illustrates such transformations.

4) Determination of a set of phases PH characteristic of a cardiac cycle based on said parameter P.

In a not limited embodiment, the phases characterizing a cardiac cycle CC are the following as illustrated in FIG. 4.
an isovolumetric contraction phase IVC between times t0 and t1,
an ejection phase EJC between times t1 and t2,
an isovolumetric relaxing phase IVR between times t2 and t3, and
a relaxation phase RLX between times t3 and t4.

During these four phases, the aorta valve AV and the mitral valve MV are open or closed as described hereinafter.

Valves

| Phases | AV | MV |
|---|---|---|
| IVC | Closed | Closed |
| EJC | Open | Closed |
| IVR | Closed | Closed |
| RLX | Closed | Open |

Hence, during the isovolumetric contraction phase IVC, the heart contracts within a same volume of blood. The internal pressure of the left ventricle LV increases.

When the internal pressure is higher than the external pressure of the aorta AO, the aorta valve AV opens which leads to an ejection of the blood from the left ventricle LV to the aorta AO. Two third of the volume of the blood is ejected in a healthy heart. This is the ejection phase EJC.

While the blood is ejected, the internal pressure decreases. When the internal pressure is equal to the external pressure, the aorta valve AV closes. The heart expands. This is the isovolumetric relaxation phase IVR.

When the internal pressure is lower than the external pressure of the left atrium LA, the mitral valve opens, and the blood goes from the left atrium LA to the left ventricle LV. This is the relaxation phase RLX.

Finally, when the internal pressure of the left ventricle LV is equal to the external pressure of the aorta AO, the mitral valve MV closes. The left ventricle LV is full of blood. The two valves AV and MV are closed.

The duration of the isovolumetric phases is an important indicator of the strength of the muscle, because a long time implies that the muscle is not strong enough to quickly increase the pressure within the LV cavity in order to reach the pressure either in the aorta AO for ejection or in the left atrium LA for relaxation.

It is to be noted that the set of phases is defined during one cardiac cycle CC. Therefore, in order to obtain the velocity curve for a complete cardiac cycle, one uses, for instance, an electrocardiogram ECG of the patient which shows the electrical activity of the heart and more specifically the onset of the contraction. One reminds that the systole phase is a phase where the heart HRT contracts which leads to the ejection of the blood into the arteries (the systole phase comprises the isovolumetric contraction IVC and ejection EJC phases), and the diastole phase is a phase where the heart HRT relaxes (the diastole phase comprises the isovolumetric relaxation IVR and relaxation RLX phases). Thus, the acquisition of the sequence of images SQ are for instance synchronized on said electrocardiogram ECG. In order to make the synchronization, the system SYS may use the ECG trigger ECG_T.

Such phases PH are deducted from the parameter P associated with the current region of tissue chosen PT, that is to say from the associated curve C.

In a first embodiment the set of phases PH is defined by visual assessment on the curve C associated with the region of tissue PT chosen. The user of the system SYS determines the phases and its corresponding times t by his own experience.

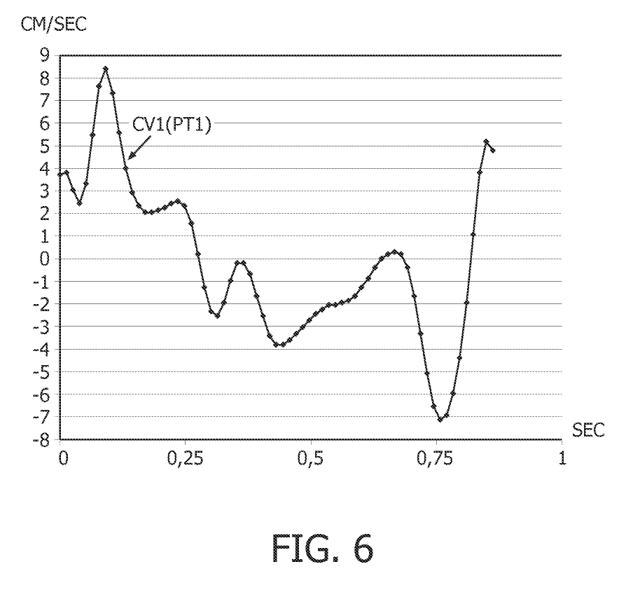

In a second embodiment, an algorithm ALG is used to define the set of phases PH on the curve C associated with the region of tissue chosen. In a first variant, it is based on a typical curve CS which shows typical phases PHS. A typical curve CS is a curve which shows a set of phases PHS during a cardiac cycle CC that comes from a healthy heart. The FIG. 4 illustrates a typical velocity curve CVE whereas the FIG. 6 illustrates an abnormal velocity curve CVE of a sick heart. The set of phases PH is then deducted from the typical phases PHS by the similarity of the two curves CS and C.

In a second variant, the algorithm ALG is based on the crossings by zero of the studied curve C and/or the time of maximum, minimum and other possible parameters such as maximum and minimum of the slope of said curve C.

As described before, the set of phases PH may be deduced, either from a velocity curve CVE, or a displacement curve CDI, or from a combination of a velocity curve CVE and a strain curve CST, or a combination of a velocity curve CVE and a strain rate curve CVG.

Hence, from a velocity curve CVE, the four phases IVC, EJC, IVR and RLX can be deduced directly.

From a displacement curve CDI, the four phases can be deduced directly on CDI or by performing a temporal derivation of said curve CDI, thus leading to a velocity curve CVE. From a strain curve CST, two phases may be deducted, the beginning of the isovolumetric contraction (t0) and the beginning of the isovolumetric relaxation IVR (t2). Then the two other phases EJC and RLX are deducted from the velocity curve CVE. It is interesting to use this combination because the two phases IVC and IVR are easier to detect in the strain curve CST as they are detected by easy finding of peaks instead of crossing by zero in a velocity curve CVE for example. Indeed, they represent the maximal value and the minimal value of strain during a cardiac cycle, where the maximal value and the minimal value correspond to a start of relaxation and a start of contraction of the myocardium respectively. The detection of such strain peaks is disclosed in a not limited example in the document WO 2004/092766 A1.

From a strain rate curve CVG, the end of the isovolumetric contraction IVC (t1) may be deducted. Then, the other phases are deducted from the velocity curve CVE.

5) Computation of a local myocardial performance index LMPI for said region of tissue PT based on the associated set of phases PH.

A LMPI index is estimated as the sum of isovolumetric contraction time and isovolumetric relaxation time divided by ejection time.

LMPI index=(IVC+IVS)/EJC

As the set of phases PH for the region of tissue PT chosen has been determined as described before, one may compute the local LMPI index.

Depending of the value of the local LMPI index computed, one may deduct if there is any failure in the region of tissue PT concerned such as for example an acute myocardial infarction.

The interest of having a local LMPI index is to show if there is a region of tissue PT in the heart which is damaged. Therefore, it is interesting to determine the LMPI index for other regions of tissues PT, which is performed as described hereinafter.

6) Determination of another region of tissues PT on said sequence of images and determination of an associated set of phases PH.

6.1) Determination of another Region PT

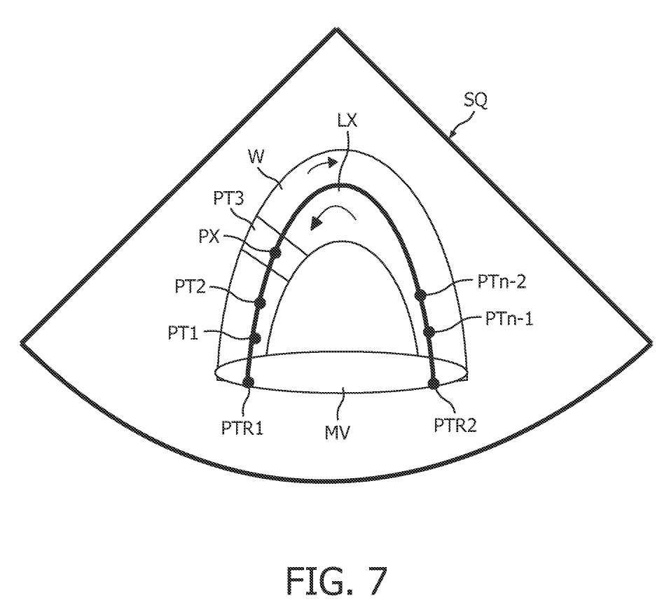

In a first embodiment, one uses a line LX along the myocardium to determine another region of tissue as illustrated in FIG. 7.

In a first variant, one determines a defined number of regions of tissue on this line LX spaced from a defined distance for example beginning from a reference region of tissue PTR1 symbolized here by a point on the FIG. 7.

In a second variant, one uses a front propagation, well-known by the person skilled in the art, based upon at least one reference region of tissue. In the example illustrated in FIG. 7, two references regions PTR1 and PTR2 have been chosen on the two borders of the mitral valve MV. The front propagation goes from the first reference region PTR1 to the second reference region PTR2 along the line LX going through the wall W of the myocardium. For each new region PT, the new reference region is the preceding region along this line LX. The reference region for the region PT1 is the region PTR1 and the reference region for the region PT2 is the region PT1 etc. . . .

In a not limited embodiment of these two first variants, a region of tissue PT is chosen so as to be perpendicular to the line LX in its length, and only one pixel PX within said region PT is taken into account to compute the set of phases PH associated to said region PT. Such a region is illustrated in FIG. 7 as PT3. Hence, the only set of phases which will be computed will be representative of all the pixels PX of said region PT as the motion of a pixel of such a region is similar to the motion of the other pixels of said region. Thus, the computation will be simpler and faster.

In another not limited embodiment of these two variants, the determination may be performed forwards and backwards as symbolized by the arrows in FIG. 7. It permits to be more precise in the determination of the set of phase described hereinafter.

In a second embodiment, the front propagation may be used without using a line LX. It is to be noted that when another region of tissue PT1, PT2 etc. . . . is defined, a parameter P corresponding to an associated curve C1, C2 etc. . . . is automatically determined as described in the step 3) before.

6.2) When another region of tissue PT1 has been chosen, the associated set of phases is defined as described hereinafter.

In a not limited embodiment, the determination is performed with Dynamic Time Warping called DTW based on a dynamic programming well-known by a person skilled in the art. The DTW permits to make a correlation between two curves.

In a first step, a correlation between the curve C1 of the current region of tissue PT1 found for instance by front propagation and the reference curve CR of the reference region PTR is performed.

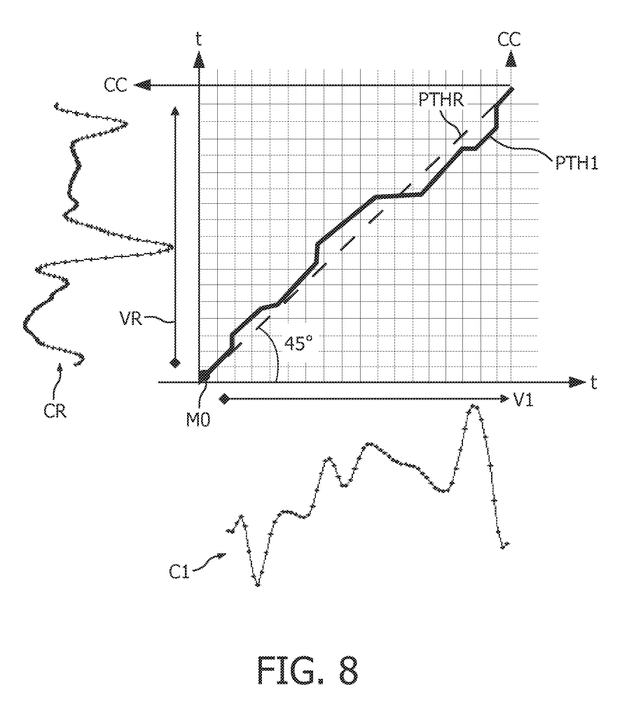

In order to perform the correlation, a time-time matrix is used to visualize a time alignment between these two curves CR and C1 as illustrated in FIG. 8 where the reference curve CR goes up the side and the curve C1 goes along the bottom. The time matrix is drawn for a cardiac cycle CC. In this not limited example, two velocity curves have been used and two vectors VR and V1 representing said velocity curves are used. These vectors characterize the reference region PTR and the current region PT1. In a not limited variant, these vectors are composed of some values forming the curves.

The time alignment is represented by a correlation path PTH. If the two curves CR and C1 were identical, the time alignment would be represented by a correlation path PTHR which would be a diagonal in said matrix with a slope of 45 degrees as illustrated in FIG. 8. If the current curve C1 was identical to the reference curve CR but with a dilatation in time, the time alignment would be represented by a correlation path PTHR which would be a diagonal in said matrix with a slope lower than 45 degrees (not represented).

In the example of FIG. 8, the two curves CR and C1 are not identical. The correlation path PTH1 has been computed and drawn to visualize the time alignment.

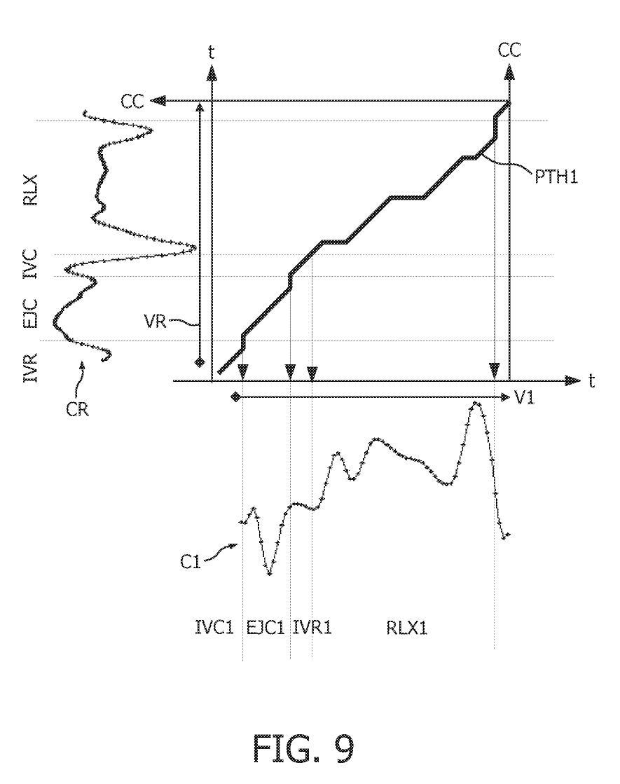

In a second step, the phases of the current curve C1 are determined with the help of said correlation path PTH1 as illustrated in FIG. 9. The interval corresponding to the first phase isovolumetric contraction IVC of the reference curve CR is projected on the correlation path PTH1 and results in an interval IVC1. The same is performed for the three other phases ejection, isovolumetric relaxation and relaxation. Therefore, the phases IVC1, EJC1, IVR1 and RLX1 are found for the current curve C1 corresponding to the current region of tissue PT1.

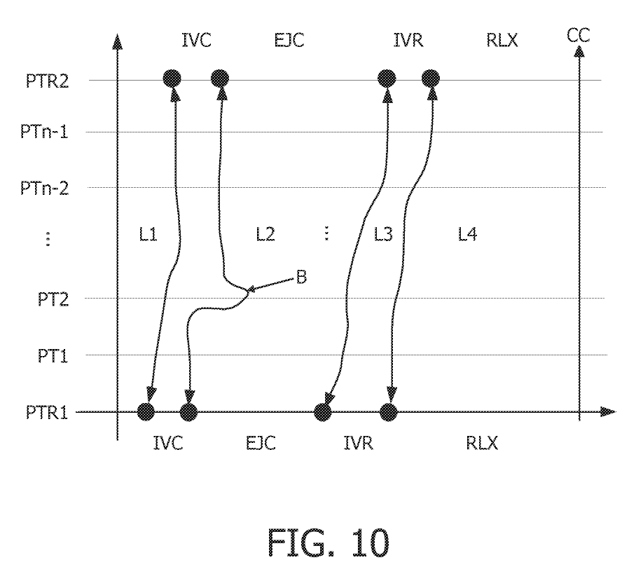

In a first variant of said DTW process, when a line LX along the myocardium is used with the front propagation, a set of phases for a current region PT computed may be corrected as described hereinafter. FIG. 10 illustrates the sets of phases computed for a plurality of regions PT1 to PTn-1 and the two reference regions for the beginning of the front propagation, which are the regions PTR1 and PTR2. The sets of phases are represented on the horizontal axis and the regions on the vertical axis. As the motion of two regions which are near to each other is homogeneous, their sets of phases should not be very different. It means that their respective values should be closed one from another. Hence, the development of the different sets of phases during the front propagation should be homogeneous. If it is not the case, that means that there may be an error in the computation of the DTW and therefore in the definition of the phases for the current region PT, and the computation may be performed again. In FIG. 10, the development of each phase IVC, EJC, IVC, and RLX for different nearby regions of tissue PT is symbolized by a line L1, L2, L3, L4 respectively. The first line L1, and the last two lines L3 and L4 evolves homogeneously. The second line L2 shows a break B for the region PT2. There is an error of computation. Therefore the DTW is computed again for this region PT2.

In a second variant of the DTW, two sets of phases for one region PT may be computed and the average may be kept as the good set of phase PH. This may be applied for a determination of region which goes forwards and backwards as described before.

The first and second variants may be combined together.

At the end of this DTW step, the steps 6 and 7 are performed again for other regions of tissue PT until a stop criteria. The stop criteria may be a zone Z of tissue comprising a plurality of regions of tissue PT that has been delimited by the user in a not limited example.

7) Computation of local LMPI indexes for said other regions of tissues PT based on their associated set of phases PH.

Hence, as the sets of phases PH for different regions of tissue PT on the sequence of images SQ have been determined, all the local LMPI indexes associated with those regions are available and may be computed as described before in step 5).

8) Display of a color image parameterized with the local LMPI indexes. The user of the system SYS may easily see the regions of tissues which may be damaged or not. For example, the red color may be associated with a large LMPI value, and the blue color with a low value, or there could be a color display relative to the average of LMPI values.

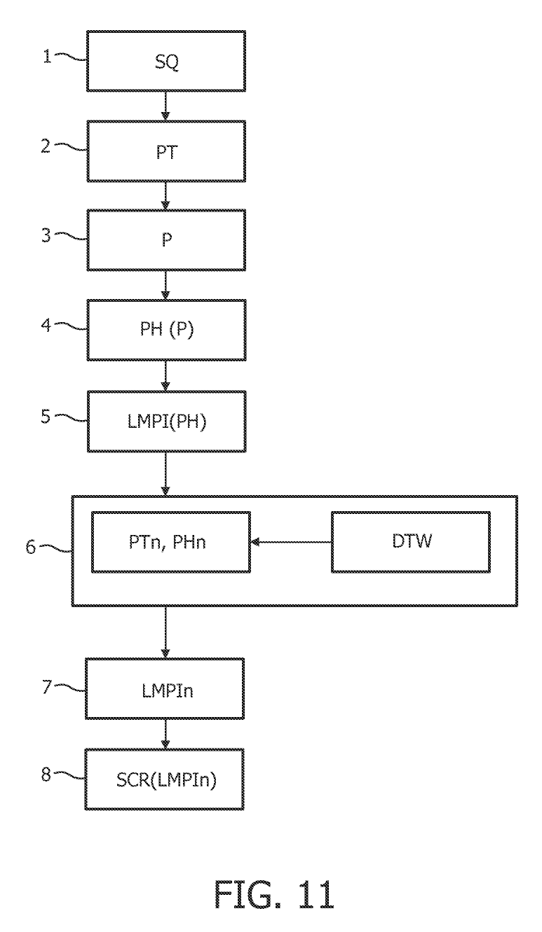

As a summary, FIG. 11 illustrates the method for medical imaging according to the invention where one can see the different operations controlled by the system SYS. Of course, some operations may be performed in parallel. For example, steps 1 and 3 may be performed in parallel.

Hence, the imaging system of the present invention that has been described comprises the following advantages:
It takes into account both the systolic and diastolic function and is independent of the heart rate and blood pressure.
Heart failure has multiple aetiologies, including coronary artery disease, primary myocardial and valvular heart disease and the defect at the myocardial level may be due to combined systolic and diastolic dysfunction, isolated systolic dysfunction, or isolated diastolic dysfunction. Therefore, the system is more advantageous than a system that permits to measure only the systolic function of the left ventricle.
The system makes it possible to distinguish patient with clinical heart failure from those without heart failure, with equivalent ventricular dysfunction.

It should be noted that the above-mentioned embodiments illustrate rather than limit the invention, and that those skilled in the art will be capable of designing many alternative embodiments without departing from the scope of the invention as defined by the appended claims.

For instance the LMPI can be computed in a 3D manner using 3D data. LMPI can also be computed not only for the left ventricle LV, but for other heart cavities such as the Right Ventricle RV. Note also that the embodiments are not restricted to any imaging modalities. The invention may be applied to any system capable of acquiring velocity information or a sequence of anatomical images.

The system SYS may be applied, in a not limited embodiment, for ultrasound images. In this case, the probe PRB is an ultrasonic probe, and the sequence of images SQ acquired is an ultrasound sequence of images.

In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa.

The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A system, comprising a controller (CTRL) for controlling the following operations:
Acquisition of a sequence of images (SQ) of an organ (HRT),
Determination of a region of tissue (PT) on said sequence of images,
Determination of a parameter (P) characteristic of motion of said region of tissue (PT),
Determination of a set of phases (PH) characteristic of a cardiac cycle based on said parameter (P),
Computation of a local myocardial performance index (LMPI) for said region of tissue (PTR) based on said set of phases (PH).

2. A system as claimed in claim 1, wherein the parameter is a velocity.

3. A system as claimed in claim 1, wherein the parameter is a displacement.

4. A system as claimed in claim 1, wherein the parameter is a combination of velocity and strain.

5. A system as claimed in claim 1, wherein the controller is also arranged to control the following operation:
Determination of another region of tissue (PT1) on said sequence of images (SQ), and
Determination of an associated set of phases (PH).

6. A system as claimed in the preceding claim, wherein the determination of another region of tissue uses a line (LX) along the organ.

7. A system as claimed in claim 5, wherein the determination of another region of tissue is performed forwards and backwards.

8. A system as claimed in the claim 5, wherein the determination of said associated set of phases is performed with dynamic time warping (DTW).

9. A method for medical imaging, comprising the steps of:
Acquiring a sequence of images (SQ) of an organ (HRT),
Determining a region of tissue (PT) on said sequence of images,
Determining a parameter (P) characteristic of motion of said region of tissue (PT),
Determining a set of phases (PH) characteristic of a cardiac cycle based on said parameter (P),
Computing a local myocardial performance index (LMPI) for said region of tissue (PT) based on said set of phases (PH).

10. A method for medical imaging as claimed in the preceding claim, further comprising a step of selecting the region of tissue (PT) by visual assessment.

11. A computer program product comprising program instructions for implementing, when said program is executed by a processor, the method as claimed in claim 9.
